(19) United States
(12) Patent Application Publication
(10) Pub. No.: US 2016/0176440 A1
(43) Pub. Date: Jun. 23, 2016

(54) METHOD AND APPARATUS FOR DETERMINING A RESULTING REFERENCE FOR CONTROLLING A STEERING DEVICE AND A VEHICLE

(71) Applicant: VOLKSWAGEN AG, Wolfsburg (DE)

(72) Inventors: Bastian WITTE, Gross Schwulper (DE); Felix KALLMEYER, Wolfsburg (DE)

(73) Assignee: VOLKSWAGEN AG

(21) Appl. No.: 14/967,278

(22) Filed: Dec. 12, 2015

(30) Foreign Application Priority Data
Dec. 22, 2014 (DE) 10 2014 226 781.1

(51) Int. Cl. B62D 15/02; B62D 5/04; G05D 1/00

(52) U.S. Cl. CPC B62D 15/025; G05D 1/0088; B62D 5/0463

(57) ABSTRACT

A method and an apparatus for determining a resulting setpoint value for regulating a steering device of a vehicle, wherein a setpoint value for the automated steering mode is determined at least in an automated steering mode of a vehicle, wherein a setpoint value for the manual steering mode is determined, wherein the resulting setpoint value is determined by changing the setpoint value for the automated steering mode as a function of the setpoint value for the manual steering mode.

### PRIORITY CLAIM

This patent application claims priority to German Patent Application No. 10 2014 226 781.1, filed 22 Dec. 2014, the disclosure of which is incorporated herein by reference in its entirety.

### SUMMARY

Illustrative embodiments relate to a method and to an apparatus for determining a resulting setpoint value for regulating a steering device of a vehicle. Illustratie embodiments also relate to a vehicle.

### BACKGROUND

Fully automatically, highly automatically or partially automatically driven vehicles are the subject matter of current development work. In the text which follows, these 3 types of automatic driving are combined under the generic term “automated steering mode”.

It is known that a setpoint value for regulating a steering device of a vehicle is determined in an automated steering mode of the vehicle, for example by means of a control unit. For example, a setpoint angle for the steerable wheels of the vehicle can be determined. The angular position of the steerable wheels is regulated precisely and with the highest possible dynamics as a function of this setpoint angle. For example, a position controller, for example referred to as a PID controller, can be used for this, to adjust a detected actual angle to the setpoint angle. An output variable of the positioning controller can be an engine torque of a servomotor or a motor current of a servomotor. The motor current can be proportional to the motor torque.

It is also known that in a manual steering mode of the steering device, which mode can also be referred to as driver control, a driver applies a manual torque to a steering column of the steering device via a steering wheel. This manual torque or steering torque can be detected by means of a suitable torque sensor. A motor torque of the servomotor or a motor current of the servomotor can then be determined in turn as a function of the detected steering torque.

However, the interplay between the two operating modes, specifically the automated steering mode and the manual steering mode, is problematic. If a driver applies a manual torque during an automated steering mode, there is a problem in how this manual intervention in the steering mode can be taken into account. If, for example, the motor torque which is determined as a function of the manual torque is added without further ado to the motor torque which is the output variable in the automated steering mode explained above, although there is a change in angle of the steerable wheels from the previous position and therefore also an initial change in the direction of travel of the vehicle, a deviation of the actual angle from the setpoint angle also occurs for the position controller which is explained above and which is activated in the automated steering mode. Therefore, the position controller will determine the output variable in such a way that this angular difference is reduced. This results in the position controller working against the driver's request. As a result, the driver feels adversely affected in his steering sensation, since the steering wheel appears to be fixed or is at least undesirably difficult to activate.

The technical problem arises of providing a method and an apparatus for determining a resulting setpoint value for regulating a steering device in a vehicle as well as a vehicle, which makes available a steering sensation which is pleasant for a driver in an automated steering mode or on the basis of an automated steering mode, when the driver applies a manual torque.

### BRIEF DESCRIPTION OF THE DRAWINGS

The disclosed embodiments will be explained in more detail with reference to the single figure, which shows a schematic block diagram of an apparatus.

FIG. 1 is a schematic view of an apparatus 1 for determining a resulting setpoint value rSW for regulating a steering device (not illustrated completely) of a vehicle. The apparatus 1 comprises a device 2 for determining an AM setpoint value aSW for automated mode or a weighted AM setpoint value. The weighted AM setpoint value is determined as a product of the AM setpoint value aSW and a first weighting factor G1. The AM setpoint value aSW can be made available by a control unit 9 for implementing an at least partially automatic mode.

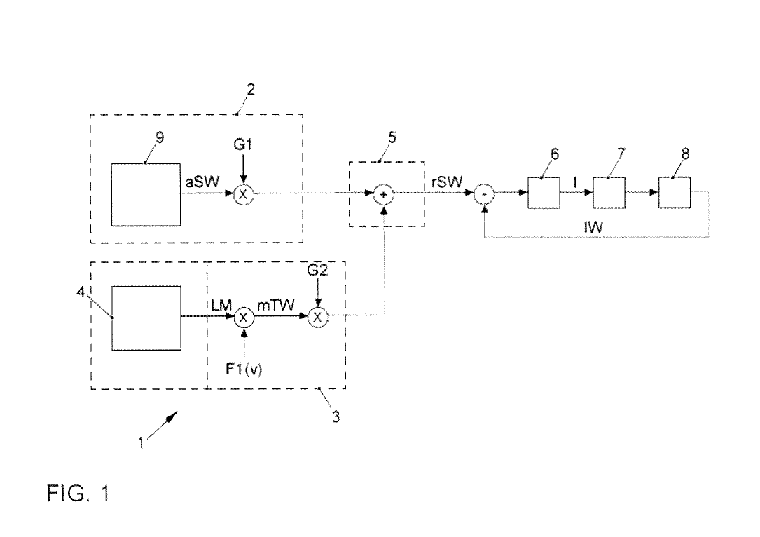

### DETAILED DESCRIPTION OF THE DISCLOSED EMBODIMENTS

A method for determining a resulting setpoint value for regulating a steering device is proposed. The steering device can be a power steering device of a (motor) vehicle. The resulting setpoint value can be a setpoint angle for steerable wheels of the vehicle. The setpoint angle can denote, for example, a setpoint wheel angle. Of course, the setpoint value can, however, also relate to all the angles which are associated with the angle of the steerable wheels. The steering device of the vehicle can denote here a device by means of which a steering angle of the steerable wheels can be set by a driver with a manual torque which is applied to a steering wheel of the steering device. The steering device can comprise this steering wheel, a steering column, a device for detecting the manual torque and a device for generating a steering torque. The device for generating a steering force can be, for example, a servomotor. The device for detecting the manual torque can be a torque sensor.

Such steering devices are known to a person skilled in the art.

The steering device can be operated here in an automated steering mode. In the automated steering mode, a corresponding control device of the steering device can determine the setpoint angle for the steerable wheels of the vehicle. This can take place, for example, as a function of a desired trajectory of the vehicle along which the vehicle is intended to move in the automated steering mode. Furthermore, the steering device can comprise a regulating device which determines an output variable (manipulated variable), as a function of the setpoint value, which is an input variable of a device for changing the steering angle. The device for changing the steering angle can be, for example, the device explained above for generating the steering torque. Furthermore the steering device can comprise a device for detecting a current actual value, wherein the steering device determines the output variable as a function of a deviation between the setpoint value and the actual value. In particular, the regulating device can be a PID control device which is known to a person skilled in the art.

In the automated steering mode, a setpoint value is determined. The value can also be referred to as an AM setpoint value. The latter can be determined both in the automated steering mode and in the manual steering mode.

The terms partially automatic, highly automatic or fully automatic describe operating modes with different degrees of automation of the control of a vehicle or of a steering mode. In addition to these operating modes, it is also possible, for example, for the operating modes “manual” mode, which can also be referred to as “driver only”, and the “assisted” operating mode to exist. These will now be explained:

In a highly automated (steering) mode of the vehicle, the lateral and longitudinal guidance of the vehicle are carried out by means of an automation system of the vehicle, wherein the driver does not have to continually monitor the automation system or the guidance of the vehicle. However, it may be necessary for the driver to be able to resume control of the guidance of the vehicle within a predetermined time period; that is to say, for example, he must not sleep. The predetermined time period can be, for example, several seconds here.

In a fully automatic operated vehicle which is a further development of the fully automated mode, the automation system performs the lateral and longitudinal guidance completely in a defined application case. In this context, the driver no longer has to monitor the automation system and the guidance of the vehicle. It is therefore not necessary for him to be able to take over the guidance of the vehicle again within a predetermined short time period; he can therefore also sleep, for example.

In a partially automatic (steering) mode, the automation system performs the lateral and longitudinal guidance, with the driver having to continuously monitor the automation system and the guidance of the vehicle.

In an assisted (steering) mode, the driver continuously carries out the lateral guidance or the longitudinal guidance. The respective other driving task is carried out within certain limits by the automation system, wherein the driver has to continuously monitor the automation system and the guidance of the vehicle.

In the manual (steering) mode, the driver continuously performs the longitudinal and lateral guidance as well as the steering.

The various operating modes can be assigned various degrees of automation. The degree of automation can decrease for the following sequence of operating modes: fully automatic mode, highly automatic mode, partially automatic mode, assisted mode and manual mode.

Apart from the setpoint value of the automated steering mode, a further setpoint value for the manual steering mode is determined. This can also be referred to as an MM setpoint value. For this purpose, the steering device can comprise a corresponding control device. The MM setpoint value for the manual steering mode can be determined as a function of a manual torque which the driver applies. The MM setpoint value therefore corresponds to the steering request by the driver. As is also explained in more detail by way of example below, the MM setpoint value can comprise a manual-torque-dependent portion and/or a vehicle-state-variable-dependent portion.

The control devices for determining the setpoint values can be embodied here as control devices which are structurally separate from one another. Of course, these control devices can, however, also be formed by a common control device.

This MM setpoint value can be determined if a steering intervention of the driver or a planned future steering intervention of the driver is detected.

The steering intervention can be detected, for example, as a function of the manual torque. The manual torque is applied by the driver. For example, the steering intervention can be detected if the manual torque is greater than zero or greater than a predetermined threshold value. The term manual torque also comprises variables which are dependent on the manual torque, in particular the steering torque which is applied to the steering column and results from the manual torque. Of course, alternative or additional criteria can also be applied to detect a steering intervention by the driver.

A planned steering intervention by the driver can be detected, for example, if the driver touches the steering wheel with at least one hand. Suitable detection devices can be provided for this. Alternatively or cumulatively, a planned steering intervention can be detected in a sensor-based fashion, with output signals of corresponding sensors being evaluated to detect a planned steering intervention.

Such methods are known to a person skilled in the art. In particular, the planned steering intervention can be detected in an image-based fashion.

Of course, it is possible for the MM setpoint value also to be determined independently of a steering intervention which is taking place or one which is planned, in particular also during the automatic steering mode.

If a steering intervention takes place, a degree of automation of the steering mode can also be reduced. For example, in the event of a steering intervention it is possible to change from an automated steering mode into a manual mode. However, it is also possible to remain in the automated mode and to take the inputs of the driver as a correction of the setpoint values in the automated steering mode. A steering intervention therefore does not necessarily lead to the deactivation of the automated steering mode and the activation of the manual steering mode but rather the vehicle can remain in the automated mode and its course can merely be corrected by the driver in the short term.

Furthermore, the resulting setpoint value is determined by changing the AM setpoint value as a function of the MM setpoint value. This also includes the case in which the resulting setpoint value is determined by changing a value which is dependent on the AM setpoint value, for example a weighted AM setpoint value. The change can be carried out here by means of a value which is dependent on the MM setpoint value, for example a weighted MM setpoint value.

Therefore, none of the regulating parameters or properties of the regulating device described above are changed but instead only a setpoint value for the operation of the regulating device explained above for the automatic mode. This results in a situation in which a driver's request can be taken into account in the automatic steering mode, without the regulating device attempting to compensate for the driver's request as an interference variable. As a result, this results in a steering sensation which is pleasant for the driver when he applies a steering torque corresponding to his driver's request in the automatic steering mode of the vehicle.

In a further disclosed embodiment, the resulting setpoint value is determined as a sum of the AM setpoint value and of the MM setpoint value. The MM setpoint value therefore constitutes an offset which is added to the AM setpoint value. As a result, a determination of the resulting setpoint value can be be determined in a way which is easily implemented and quickly executed.

In a further disclosed embodiment, a weighted AM setpoint value is determined as a product of the AM setpoint value and of an AM weighting factor. The AM weighting factor can be here a factor from a predetermined range. The range can comprise, for example, values from 0 (inclusive) to 1 (inclusive). The AM setpoint value can therefore be scaled.

Alternatively or cumulatively, a weighted MM setpoint value is determined as a product of the MM setpoint value and of an MM weighting factor. This MM weighting factor can also be a factor from a predetermined range. This range can also comprise values from 0 (inclusive) to 1 (inclusive). The MM setpoint value can therefore also be scaled.

Furthermore, the resulting setpoint value is determined as a sum of the weighted setpoint values.

As is explained in more detail below, by way of example, AM and MM weighting factors can be variable over time. However, a level of the change over time can be limited, in particular to a maximum permissible change.

This results in weighting of the portion of the setpoint value for the automatic steering mode and of the portion of the setpoint value for the manual steering mode in the resulting setpoint value, wherein the weighting can be variable over time.

In particular, AM and MM weighting factors can be adjusted or changed in such a way that the sum of the AM and MM weighting factors is constant. For example, the sum can have the value 1.

By changing the weighting factors it is possible to perform what is referred to as cross-fading between automatic and manual steering modes, consequently between the AM setpoint value and the MM setpoint value. If, for example a steering intervention of the driver is detected during automatic steering, the MM weighting factor can be increased. Alternatively or cumulatively, the AM weighting factor can be reduced.

For example, the changing, that is to say the increasing or reducing, of the weighting factors can take place in chronologically offset or simultaneous fashion. Therefore, the MM weighting factor can be increased while the AM weighting factor is reduced in a chronologically offset fashion. For example, the AM weighting factor can be reduced after the ending of the increasing of the MM weighting factor. However, it is also conceivable for the AM weighting factor to be at least partially or completely changed simultaneously.

Of course, it is conceivable for the changing of the weighting factors to be an alternative to or in addition to the detection of the steering intervention depending on the satisfaction of further criteria. For example, the changing may take place only when a manual torque exceeds a predetermined threshold value, where appropriate for a predetermined time period.

Suitably adjusting the weighting factors can improve the steering sensation of the driver, in particular in the transition region between automatic and manual steering modes.

In a further disclosed embodiment, the AM weighting factor and the MM weighting factor are adjusted as a function of a desired degree of automation of the steering mode. The term “adjust” comprises here, in particular, also changing of the weighting factors. For this, a degree of automation of the steering mode can be determined. A minimum value of a weighting factor can be, in particular, “0”, while a maximum value can be, in particular, “1”.

If a degree of automation is determined which corresponds to the automatic steering mode, the AM weighting factor can be adjusted to the maximum value. The MM weighting factor can be adjusted to a minimum value.

For example, for training purposes for a learner driver the AM weighting factor can be adjusted to a value which is different from the minimum value. The MM weighting factor can also be adjusted to a value that is different from the minimum value. In this context it is possible for one or both weighting factors to be set to the respectively correspondingly maximum value. However, it is also possible for the respective weighting factors to be adjusted to values which are different from the corresponding maximum value.

In the manual steering mode, the MM weighting factor can be adjusted to the maximum value, with the AM weighting factor being adjusted to the minimum value.

For example in computer games it is known to offer the driver different degrees of assistance (for example automatic transmissions or manual gearshift, acceleration/braking separately or a common actuator lever etc.). For training purposes for a driver, a training mode can be defined in which it is possible to cross-fade between the automatic and the manual steering modes. At maximum, the vehicle would drive in the automated steering mode and minimally drive in the manual steering mode. Intermediate stages in which the driver attempts to follow the ideal trajectory of the automatic steering mode as far as possible by manual steering are also conceivable. The closer the training mode is to the automatic steering mode, the higher the level at which the AM weighting factor is set, and therefore lower the level at which the MM weighting factor is set. Depending on how close the training mode is set to the manual steering mode, the higher the level at which the MM weighting factor is set, and the lower the AM weighting factor is set. In this case, the driver can be a learner driver or a person who is learning to drive a racing car and who wishes to get to know a new racetrack and the optimum trajectory in terms of timing for the race track.

Overall, it becomes apparent that by adjusting the weighting factors as a function of a desired degree of automation, a changeover between the various operating modes is made possible, with the steering sensation which is pleasant for the driver being made available at all times.

In a further disclosed embodiment, the AM weighting factor is reduced and/or the MM weighting factor is increased if a reduction in the degree of automation is detected. This would has already been explained above. In particular, after the detection of the reduction in the degree of automation, the MM weighting factor is firstly increased, with the AM factor being then reduced chronologically. The AM weighting factor can, for example, be reduced only after the change in the MM weighting factor.

However, the reduction and the increase can take place completely simultaneously or at least partially simultaneously. As a result, when the degree of automation is reduced, this results in a situation in which a driver's request is weighted to a greater extent, and therefore taken into account to a greater extent.

In at least one disclosed embodiment, the MM setpoint value comprises at least one manual-torque-independent portion, wherein the manual-torque-dependent portion is determined as a function of a level and a direction of a manual torque. In particular there can be a previously known relationship between the manual torque and the MM setpoint value, for example, a function or a characteristic diagram. This results in the driver's request being particularly reliably taken into account, since the MM setpoint value which changes the AM setpoint value is determined as a function of a manual torque which is supplied by the driver.

In a further disclosed embodiment, the manual-torque-dependent portion is determined as a product of the manual torque with a manual-torque-scaling factor. The manual-torque-scaling factor can be here a factor composed of a predetermined region. This results in determination of the manual-torque-dependent portion in a way which is easy to implement and can be carried out quickly.

In a further disclosed embodiment, a level of the manual-torque-scaling factor is dependent on a vehicle velocity. In this context, the vehicle speed can be determined by means of a speed sensor of the vehicle. Furthermore, there can be a previously known relationship between the vehicle speed and manual-torque-scaling factor, for example, a function or a characteristic diagram. In particular, the manual-torque-scaling factor can be reduced as the vehicle speed increases.

This results in increased operational reliability during the operation of the vehicle, since at high vehicle speeds the change in the resulting setpoint value which results from the driver's request is taken into account to a lesser extent. As a result, the reaction of the vehicle which is stronger in the case of a high vehicle speed to changes in the steering angle than at vehicle speeds which are lower in comparison can be limited.

The MM setpoint value can comprise here just the manual-torque-dependent portion. In particular, the MM setpoint value can be equal to the product of the manual torque with the manual-torque-scaling factor. However, it is alternatively or additionally also possible for the MM setpoint value to comprise at least one further portion or to correspond to a further portion which is different from the portion which is dependent on the manual torque.

In a further disclosed embodiment, the MM setpoint value comprises at least one state variable portion, in which the state variable portion is determined as a function of at least one vehicle state variable. The vehicle state variable can be, in particular, a state variable for performing closed-loop or open-loop control of the steering mode. In particular, the portion can be determined as a function of one or more or of all of the subsequent variables: steering angle, wheel angle, lateral acceleration, steering angle speed, yaw rate.

The MM setpoint value can comprise just the state variable portion here. However, it is also possible for the MM setpoint value to be determined as a function of the manual-torque-dependent portion as well as as a function of the state variable portion. In this context, there can be a previously known relationship between the MM setpoint value and the portions, for example, a function or a characteristic diagram. For example the MM setpoint value can be determined as a sum of the portions.

Taking into account a state variable portion in the determination of the MM setpoint value results in a situation in which an MM setpoint angle which is different from 0 can be determined even in the event of no manual torque being applied by the driver. This is, in particular, when the AM weighting factor explained above is low, while the MM weighting factor is high. It is therefore possible, for example, for what is referred to as center resetting of the steerable wheels to take place if no manual torque is applied but the setpoint value for the automatic steering mode during the determination of the resulting setpoint value is not taken into account, or is only taken into account to a small degree, in the determination of the resulting setpoint value. This results in improved operation of the vehicle.

In a further disclosed embodiment, the resulting setpoint value is a setpoint angle of, or a setpoint torque for, steerable wheels. This has already been explained above. This results in a situation in which the proposed method can easily be implemented in existing steering devices.

An apparatus for determining a resulting setpoint value for regulating a steering device of a vehicle is also proposed, wherein the apparatus comprises at least one device for determining an AM setpoint value and at least one device for determining an MM setpoint value as well as a device for determining the resulting setpoint value. The devices here can be embodied, in particular, by means of a control unit or a plurality of control units of the vehicle. Furthermore, the devices can be made available as structurally separate devices or by means of a common device, in particular a common control unit.

The AM setpoint value can be determined at least in an automatic steering mode of the vehicle.

An MM setpoint value can be determined. Furthermore, the resulting setpoint value can be determined by changing the AM setpoint value as a function of the MM setpoint value. The determination can be carried out here by means of the corresponding device.

The proposed apparatus permits a method to be carried out according to at least one of the embodiments explained above. The apparatus is embodied, in particular, in such a way that a method according to at least one of the embodiments explained above can be carried out by means of the apparatus.

In particular, the proposed apparatus can be in the control unit of the steering device or can be made available thereby.

A vehicle is also proposed which comprises an apparatus according to the embodiment explained above. This results in a vehicle which permits an improved steering sensation for a driver during an automatic steering mode of the vehicle when there is steering intervention by the driver.

Furthermore, the apparatus 1 comprises a device 3 for determining an MM setpoint value mTW for a manual mode or for a weighted MM setpoint value. The weighted MM setpoint value mTW is determined as a product of the MM setpoint value mTW and a further weighting factor G2. A steering torque sensor 4, which senses a steering torque LM, is also illustrated. The steering torque LM is here a variable which is proportional to a manual torque. The steering torque LM denotes a torque which is present at a steering column of the steering device.

The MM setpoint value mTW is determined as a product of the detected steering torque LM with a manual torque scaling factor F1. The manual torque scaling factor F1 is dependent on a vehicle velocity v of the vehicle.

The weighting factors G1, G2 can be weighting factors which can vary over time here. In particular, these weighting factors can be adjusted as a function of a desired degree of automation of the steering mode. For example, the AM weighting factor G1 can be reduced and the MM weighting factor G2 can be increased if a reduction in the degree of automation is detected.

A device 5 for determining the resulting setpoint value rSW which is determined as a sum of the weighted AM setpoint value and the weighted MM setpoint value is also illustrated. A regulating device 6, which adjusts a phase current I of an electric machine 7 of the steering device as a function of a difference between the resulting setpoint value rSW and an actual value IW, is also illustrated. The phase current I denotes here a motor current and is proportional to a torque which is generated by the electric machine 7 and serves to adjust the steering angle of the steerable wheels of the vehicle. A steering angle sensor 8, which detects the actual angle IW, is also illustrated.

It is known that a setpoint value for regulating a steering device of a vehicle is determined in an automated steering mode of the vehicle, for example by means of a control unit. For example, a setpoint angle for the steerable wheels of the vehicle can be determined. The angular position of the steerable wheels is regulated precisely and with the highest possible dynamics as a function of this setpoint angle. For example, a position controller, for example referred to as a PID controller, can be used for this, to adjust a detected actual angle to the setpoint angle. An output variable of the positioning controller can be an engine torque of a servomotor or a motor current of a servomotor. The motor current can be proportional to the motor torque.

It is also known that in a manual steering mode of the steering device, which mode can also be referred to as driver control, a driver applies a manual torque to a steering column of the steering device via a steering wheel. This manual torque or steering torque can be detected by means of a suitable torque sensor. A motor torque of the servomotor or a motor current of the servomotor can then be determined in turn as a function of the detected steering torque.

However, the interplay between the two operating modes, specifically the automated steering mode and the manual steering mode, is problematic. If a driver applies a manual torque during an automated steering mode, there is a problem in how this manual intervention in the steering mode can be taken into account. If, for example, the motor torque which is determined as a function of the manual torque is added without further ado to the motor torque which is the output variable in the automated steering mode explained above, although there is a change in angle of the steerable wheels from the previous position and therefore also an initial change in the direction of travel of the vehicle, a deviation of the actual angle from the setpoint angle also occurs for the position controller which is explained above and which is activated in the automated steering mode. Therefore, the position controller will determine the output variable in such a way that this angular difference is reduced. This results in the position controller working against the driver's request. As a result, the driver feels adversely affected in his steering sensation, since the steering wheel appears to be fixed or is at least undesirably difficult to activate.

DE 10 2008 002 669 A1 discloses a method for operating a lane keeping support system, wherein a normal regulating mode takes place if no driver intervention occurs, wherein the regulating mode is switched over if the driver performs a steering intervention by changing the regulating parameters without deactivating the regulating process and/or a feedback process. However, this document only describes that an I portion and/or D portion of a PID controller can be changed.

### LIST OF REFERENCE SYMBOLS

1 Apparatus
2 Device for determining the setpoint value for the automatic steering mode
3 Device for determining the setpoint value for the manual steering mode
4 Steering torque sensor
5 Device for determining the resulting setpoint value
6 Regulating device
7 Electric machine
8 Angle sensor
aSW Setpoint value for the automated steering mode
mTW Setpoint value for the manual steering mode
rSW Resulting setpoint value
G1 AM weighting factor
G2 MM weighting factor
F1 Manual-torque-scaling factor
v Vehicle velocity
IW Actual angle

1. A method for determining a resulting setpoint value rSW for regulating a steering device of a vehicle, the method comprising:
determining a setpoint value aSW for the automated steering mode at least in an automated mode of a vehicle; and
determining a setpoint value mTW for the manual steering mode;
wherein the resulting setpoint value rSW is determined by changing the setpoint value aSW for the automated steering mode as a function of the setpoint value mTW for the manual steering mode.

2. The method of claim 1, wherein the resulting setpoint value rSW is determined as a sum of the setpoint value aSW for the automated steering mode and of the setpoint value mTW for the manual steering mode.

3. The method of claim 2, further comprising determining a weighted setpoint value for the automated steering mode as a product of the setpoint value aSW for the automated steering mode and an AM weighting factor G1 and/or a weighted setpoint value for the manual steering mode as a product of the setpoint value mTW for the manual steering mode and an MM weighting factor G2, wherein the resulting setpoint value rSW is determined as a sum of the weighted setpoint value.

4. The method of claim 3, wherein the AM weighting factor G1 and the MM weighting factor G2 are set as a function of a desired degree of automation of the steering mode.

5. The method of claim 3, wherein the AM weighting factor G1 is reduced and/or the MM weighting factor G2 is increased if a reduction in the degree of automation is detected.

6. The method of claim 1, wherein the setpoint value mTW for the manual steering mode comprises at least one manual-torque-dependent portion, wherein the manual-torque-dependent portion is determined as a function of a level and a direction of a manual torque.

7. The method of claim 6, wherein the manual-torque-dependent portion is determined as a product of the manual torque with a manual-torque-scaling factor F1.

8. The method of claim 7, wherein the level of the manual-torque-scaling factor F1 is dependent on a vehicle velocity v.

9. The method of claim 1, wherein the setpoint value mTW for the manual steering mode comprises at least one state variable portion, wherein the state variable portion is determined as a function of at least one vehicle state variable.

10. The method of claim 1, wherein the resulting setpoint value rSW is a setpoint angle or setpoint torque.

11. An apparatus for determining a resulting setpoint value rSW for regulating a steering device of a vehicle, wherein the apparatus comprises:
at least one device 2 for determining a setpoint value aSW for an automated steering mode;
at least one device 3 for determining a setpoint value mTW for the manual steering mode; and
a device 4 for determining the resulting setpoint value rSW,
wherein the setpoint value aSW for the automated steering mode can be determined at least in the automated steering mode of the vehicle,
wherein a setpoint value TW can be determined for the manual steering mode, and
wherein the resulting setpoint value rSW can be determined by changing the setpoint value aSW for the automated steering mode as a function of the setpoint value mTW for the manual steering mode.

12. A vehicle, comprising an apparatus for determining a resulting setpoint value rSW for regulating a steering device of a vehicle, wherein the apparatus comprises at least one device 2 for determining a setpoint value aSW for an automated steering mode, at least one device 3 for determining a setpoint value mTW for the manual steering mode; and a device 4 for determining the resulting setpoint value rSW, wherein the setpoint value ASW for the automated steering mode can be determined at least in the automated steering mode of the vehicle, wherein a setpoint value TW can be determined for the manual steering mode, and wherein the resulting setpoint value rSW can be determined by changing the setpoint value aSW for the automated steering mode as a function of the setpoint value mTW for the manual steering mode.
